(19) United States
(12) Patent Application Publication
(10) Pub. No.: US 2006/0294001 A1
(43) Pub. Date: Dec. 28, 2006

(54) System and method for trading instruments using a data communications network

(76) Inventors: James Robert Foster, London (GB); Neill Penney, Surrey (GB)

Correspondence Address: LAW OFFICES OF GRADY L. WHITE, LLC, 7272 WISCONSIN AVE, SUITE 300, BETHESDA, MD, 20814, US

(21) Appl. No.: 11/471,274

(22) Filed: Jun. 20, 2006

Related U.S. Application Data
(60) Provisional application No. 60/691,800, filed on Jun. 20, 2005.

(51) Int. Cl. G06Q 40/00

(52) U.S. Cl. 705/37

(57) ABSTRACT

The invention provides a computer system and method for trading instruments using a data communications network which allows users to selectively view market depth information for the instruments in a plurality of different styles, each style corresponding to one of the plurality of available market depth views. The user can switch back and forth between the plurality of market depth views, as many times as he likes, by using an input device to activate a control on a trading panel to select from the plurality of available views. The system includes a network interface for receiving a set of orders for the instrument from the data communications network, a display device, and a view processor configured to display on the display device a trading panel comprising a market depth grid containing sizes and rates that are derived from the set of orders received from the data communications network. The sizes and rates displayed on the market depth grid are determined by the selected market depth view.

### CROSS-REFERENCE TO RELATED APPLICATIONS

This application is related to and claims priority under 35 U.S.C. § 119 to provisional application No. 60/691,800, filed on Jun. 20, 2005, which is incorporated into this application in its entirety by this reference.

### FIELD OF ART

The present invention relates generally to electronic trading systems for exchange-style trading of assets, such as stocks, currency, commodities and financial instruments, over a data communications network. More particularly, the invention relates to exchange-style trading systems having graphical user interfaces that present users with market depth information in the form of market depth grids.

### RELATED ART

Online trading exchanges typically operate by allowing multiple traders to use online trading software running on one or more personal computers or workstations to log into to a centralized trading server via an interconnected data communications network, such as the Internet. The trading server typically contains an order management system (OMS), which includes a database containing the details for all of the as-yet unexecuted bids and offers that have been submitted by the multiple traders who are logged on. Each bid and each offer contained in the order book typically comprises, among other things, the name of the instrument to be traded, the “size” of the bid or offer (i.e., the amount of the instrument or commodity to be traded) and the rate (i.e., the price for trading the specified amount). These details are consolidated, downloaded and displayed on the personal computers or workstations used by traders to gain access to the trading server, thereby providing each trader with a snapshot of the market.

The software running on the individual traders' personal computers or workstations also permit the individual traders to submit their own bids and offers to the trading server, which bids and offers are entered into the order book, consolidated with all of the other bids and offers for the same instrument or commodity, and subsequently made available for all of the other traders to download and review. The software programs which display the market data to the traders also permit the traders to execute trades based on the set of bids and offers received from the trading server.

In an electronic exchange system, the “market” for an instrument comprises a plurality of bids and offers available for that instrument. When a trader submits a bid price (or bid “rate”) for an instrument, he is essentially informing other traders logged into the exchange server of the price (or “rate”) at which he is willing to buy the instrument. When a trader submits an offer price, he is informing other traders logged onto the exchange server of the price (rate) at which he is willing to sell the instrument. For this reason, an offer price is often referred to in the business as an “ask” price, as in “this is the price the trader is asking.” Typically, bids and offers have associated with them a “size” or “amount” component, which represents the quantity of the instrument or commodity the trader is willing to buy or sell at the specified rate.

The “bid/offer spread” (sometimes referred to as the “bid/ask spread,” or simply “the spread”) for an instrument is the distance between the best bid price and best ask price. A tighter spread is usually better for the trader. In the foreign exchange (FOREX) markets, the spread is usually measured in “pips,” which is the smallest price increment in a currency. For example, in EURUSD, a move from 0.9015 to 0.9016 is one pip. In USDJPY, a move from 128.51 to 128.52 is one pip. Pips are often referred to as “ticks” in the futures markets.

The “market depth” for an instrument or commodity refers to the rates existing in the market that are less favorable than the best bid and best offer. Graphical user interfaces for online trading programs typically display this market depth information to users in the form of a grid, called a “market depth grid,” which contains a plurality of existing bid and offer rates for the instrument or commodity, as well as their associated sizes. As will be described below, the market depth grid, which is typically updated in real time, conveys to the trader information the trader will need in order to asses the status of the market for a particular instrument or commodity, and make key decisions concerning particular transactions the trader wishes to complete.

Table 1 below illustrates the typical layout of the market depth grids produced by existing online trading systems.

TABLE 1
Market Depth Grid

| | |
|---|---|
| BIDS | OFFERS |

| SIZE ($M) | RATE | RATE | SIZE ($M) |
|---|---|---|---|
| 10 | 80 | 82 | 5 |
| 20 | 75 | 84 | 10 |
| 30 | 70 | 86 | 15 |

As shown in Table 1, the typical market depth grid provided by the existing online trading systems contains columns showing the consolidated lot sizes, in millions of dollars, and rates for bids and offers currently existing in the marketplace for an instrument or commodity. In this case, bid sizes and rates are shown in the two left-most columns and offer rates and sizes are shown in the two right-most columns. Each row shows the rate and the consolidated size available for that rate. Each size value in the market depth grid represents the consolidated total size of the instrument available at the specified rate. Thus, the row which contains the size value of 10 and the rate value of 80 could mean that five different traders are each willing to buy $2 million worth of the commodity at the rate of 80, that two different traders are each willing to buy $5 million worth at the rate of 80, or that a single trader is willing to buy all $10 million worth of the commodity at the rate of 80.

Accordingly, a trader presented with the particular market depth grid shown in Table 1 would understand from looking at the first row that one or more other traders have posted bids indicating that they are willing to buy the specified instrument or commodity at a rate of 80, and that the combined lot size for all bids in the market having that rate is $10 million. Based on this information, the trader would further understand that he can sell $10 million worth of the instrument at the rate of 80. He would know, however, that if he needs to sell more than $10 million worth of the instrument, every unit he sells above the size of $10 million will be sold at the lower rate of 75, as indicated by the second row. If that lower rate of 75 is acceptable, then he could sell up to an additional $20 million worth of the instrument at this rate. He would also know from looking at the values in this grid that if he needs to sell more than $30 million worth of this instrument, the rate he will get for every unit sold above the first $30 million drops to 70. Based on the grid in Table 1, he would also understand that the market shows a total of $60 million available (10+20+30).

The typical market depth grid produced by existing online trading systems also shows offers in the marketplace or exchange for the instrument (i.e., the rates at which other traders are willing to sell the instrument). In this case, the market depth grid shows that the marketplace or exchange contains offers at the rates of 82, 84 and 86, and that the consolidated sizes available for these rates are $5 million, $10 million and $15 million, respectively. Thus, if the trader wanted to buy the instrument at the rate of 82, there is $5 million available in the market. If the trader wishes to buy more than $5 million, there would be an additional $10 million worth available at the higher rate of 84. And finally, if the trader needs or wants to buy even more units of the instrument or commodity (that is, more than $15 million), then there would be an additional $15 million available at the even higher price of 86.

There are several problems associated with using online trading systems that produce market depth grids like the one shown in Table 1. First, as illustrated by the examples above, the market depth grids produced by the conventional online trading systems merely show the sizes associated with each bid or offer in the marketplace. These grids do not actually show what the rates are for any particular size transaction. Consequently, traders wishing to trade in some arbitrary or odd size, such as $54 million, cannot ascertain at a glance where on the market depth grid that $54 million figure will land and which rates will apply. To understand where a large sized trade will fall with respect to the grid (and, therefore, which rates will apply), the trader must first add together (accumulate) enough sizes shown in the size column of the grid so that the sum matches or approximates the amount he intends to trade. Although performing these calculations is not usually a difficult task, it does take some finite amount of time to accomplish. In the fast paced environment of electronic trading, where rates change rapidly and really good bids and offers are usually consumed very fast, every second a trader has to spend performing additional calculations and analysis puts that trader at a competitive disadvantage.

Second, traders do not always wish to buy or sell instruments in the sizes shown in the best price row (or in any particular row) of a standard market depth grid. Often, it is necessary or desirable to buy or sell instruments in sizes that are much larger than the sizes associated with the best rates. Selling or buying in these larger sizes require paying or receiving several different rates for the same instrument, depending on the quantity of instruments traded. When this happens, the overall effective rate for the transaction changes substantially. Unfortunately, the market depth grids produced by the existing online trading systems do not provide the overall effective rate; nor do they provide enough information for the trader to quickly and accurately determine what that overall effective rate will be prior to executing on the trade.

Suppose, for example, that a trader looking at the market depth grid in Table 1 needed to sell $15 million worth of the instrument. The market depth grid would show that if he sells $15 million worth of the instrument, he would get a rate of 80 for the first $10 million and only 75 for the other $5 million. If the trader needed to sell $25 million, then the market depth grid of table 1 shows that he would get 80 for the first $10 million, 75 for the second $10 million and only 70 for the other $5 million. However, nothing in the market depth grid would quickly and accurately convey to the trader exactly what his overall effective rate would be for these transactions.

Sometimes traders need to buy or sell instruments in larger sizes, but still have some degree of flexibility when it comes to deciding exactly how large a transaction they should execute. In such cases, traders may be more concerned with determining where the “sweet spot” exists in the market than they are with executing a particular size transaction. In other words, the trader may need or want to compare a plurality of effective rates for a plurality of transaction sizes so that he can quickly and accurately determine where there exists a large jump or drop in effective price. If this information was made available, then the trader could quickly and easily identify and execute at the transaction size that occurs just before the large jump or drop in price, thereby achieving “the most bang for his buck.” The conventional online trading systems also do not provide market depth grids that convey this information to the user.

Accordingly, there is considerable need in the online trading business for an online trading system capable of presenting users with a market depth grid that displays market depth information according to a plurality of different views and in a manner that, depending on the particular context, as well as the specific objectives and preferred trading style of the user, comprises a significantly more useful and intuitive representation of market information pertaining to the particular instrument to be traded. It would be even more desirable for this system to be capable of permitting the user to dynamically and selectively switch between the plurality of market depth views prior to executing a trade.

### SUMMARY OF THE INVENTION

The present invention addresses the above-described needs, as well as other disadvantages associated with conventional trading systems, by providing a computer system for trading an instrument using a data communications network. The computer system includes a network interface for receiving a set of orders for the instrument from the data communications network, a display device, and a view processor configured to display on the display device a trading panel comprising a market depth grid for the instrument to be traded. The set of orders comprises a plurality of bids and offers each one pertaining to the instrument to be traded.

The trading panel includes a control, such as a user-activatible button, icon, drop down menu, or the like, which is configured to provide access to a plurality of available market depth views for the market depth grid. The computer system also includes an input device, such as a keyboard, a mouse or other pointing or selection device, which can be operated by a user to activate the control in the trading panel to select a desired market depth view from the plurality of available market depth views. Activating the control with the input device to select the desired market depth view causes the view processor to populate the market depth grid with sizes and rates that are derived from the set of orders received from the data communications network. The sizes and rates are calculated and displayed in the trading panel in a manner that is consistent with the selected desired market depth view. Thus, prior to initiating a trade on the instrument, the user can selectively view market depth information for the instrument in a plurality of styles, each style corresponding to one of the plurality of available market depth views. Moreover, the user can switch back and forth between the plurality of market depth views, as many times as he likes, by using the input device to activate the control on the trading panel to select from the plurality of different available views.

The plurality of market depth views comprises at least one of the following: a size against rate view, a cumulative size against rate view, a cumulative size against effective rate view, and a configured size against effective rate view. In some embodiments the invention includes all of these different views. The size against rate view comprises a standard market depth view like the one shown in Table 1 above. In other words, this view shows the rates on either side of the best bid and offer, and the actual size (amount) available at that rate. The cumulative size against rate view, differs from the size against rate view in that the sizes in the grid are summed so that a user can immediately ascertain, for example, exactly where on the market depth grid a proposed transaction size will fall, as well as the total size for all bids and offers in the market depth view. The cumulative size against effective rate view shows the cumulative size and the effective rate that would be achieved if the user were to match with the cumulative size in a trade.

The size values that appear in the standard market depth grid are usually produced by adding up the size components for every bid and offer having a certain rate component. For example, if five traders have each submitted bids to buy $3 million worth of a certain instrument or commodity at the rate of 80, then the existing online trading systems would produce a market depth grid having a row with a rate value of “80” and a size value of “15.” This would tell the trader that $15 million worth of the instrument or commodity is available at the rate of 80. In some situations, however, a user may need to determine the rate he would get if he were to trade an instrument in one or more specific lot sizes. The present invention addresses this need by permitting the user to specify a preferred set of configured sizes and then select a market depth view that produces a market depth grid having size components equal to the sizes in the preferred set of configured sizes. Thus, the configured size against effective rate view displays the sizes which have been configured by the user, and the effective rate that would be achieved if the user were to execute in one of the configured sizes. With this view, the user can quickly make a decision as to which configured size is the most efficient for him to trade.

In embodiments where one of the plurality of market depth views comprises the configured size against effective rate view, the trading panel may include a second control for specifying the preferred set of configured sizes. The input device can be operated to activate the second control and, responsive to activation of the second control, the view processor will populate the market depth grid with sizes that are equal to the set of configured sizes and rates that are derived from the set of orders and the preferred set of configured sizes.

Each of the above-described market depth views will be discussed in more detail below with reference to FIGS. 3 through 9.

In some embodiments, the computer system of the present invention also includes a memory (such as random access memory or a hard drive) for storing the set of orders received from the data communications network via the network interface. Prior to calculating the values for the sizes and rates to use in the market depth grid, the view processor retrieves the set of orders from this memory. Preferably, the computer also uses this memory (or, alternatively, another memory area residing on or connected to the computer) to store a set of user preferences, such as a default or previously-selected desired market depth view, or a default or previously-selected set of configured sizes.

The trading panel may also include an instrument selection control, which can be activated by the input device to select from a plurality of instruments that may be traded on the data communications network. Thus, a user can use the input device, for example, to switch from monitoring and displaying market depth information for EURUSD to monitoring and displaying market depth information for USDJPY. Operating the input device to select a new instrument causes the view processor to delete current set of orders, as well as the sizes and rates currently displayed in the market depth grid.

The computer system of the present invention will produce a new market depth grid whenever the user uses the input device to change the desired market depth view, change the set of configured sizes or change the instrument to be traded. In preferred embodiments, the system will also produce a new market depth grid whenever the network interface receives a new order, a new set of orders, or an instruction to delete a previously-received order or set of orders. Thus, in response to receiving a new set of orders, the view processor will re-populate the market depth grid with sizes and rates that are derived from the new set of orders and which are consistent with the currently-selected market depth view.

Preferred embodiments of the invention will also permit users to execute trades against orders by selecting a size or rate shown in the market depth grid. When the user activates the input device to select a size shown in the market depth grid, the system executes a trade for the instrument, the trade having a size component equal to the selected size. Similarly, when the user activates the input device to select a rate shown in the market depth grid, the system executes a trade having a rate component equal to the selected rate.

In another aspect of the invention, there is provided a method for trading an instrument using a data communications network. The method includes the steps of: (1) providing a network interface configured to receive a set of orders for the instrument from the data communications network; (2) providing a display device and an input device; (3) displaying on the display device a trading panel comprising a market depth grid for the instrument and a control that can be activated by the input device to select a desired market depth view from a plurality of available market depth views for the market depth grid; and (4) populating the market depth grid with sizes and rates that are derived from the set of orders and consistent with the desired market depth view in response to receiving the selection of the desired market depth view; (5) whereby, prior to initiating a trade on the instrument, a user can selectively view market depth information for the instrument in a plurality of styles, each style corresponding to one of the plurality of available market depth views.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include depictions of the exemplary embodiments. In these drawings:

FIG. 1 contains a high-level block diagram illustrating the major functional components of a computer system configured to operate according to an embodiment of the invention.

FIG. 2 contains high-level flow diagram illustrating the steps that may be performed by a computer system, such as the computer system depicted in FIG. 1, configured to operate according to embodiments of the invention.

FIGS. 3 through 9 contain exemplary trading panels that could be used for trading instruments according to embodiments of the present invention.

### DETAILED DESCRIPTION

With reference to the figures, a detailed discussion of exemplary embodiments of the invention will now be presented. Notably, the invention may be implemented using software, hardware, firmware, or any combination thereof, as would be apparent to those of skill in the art upon reading this disclosure.

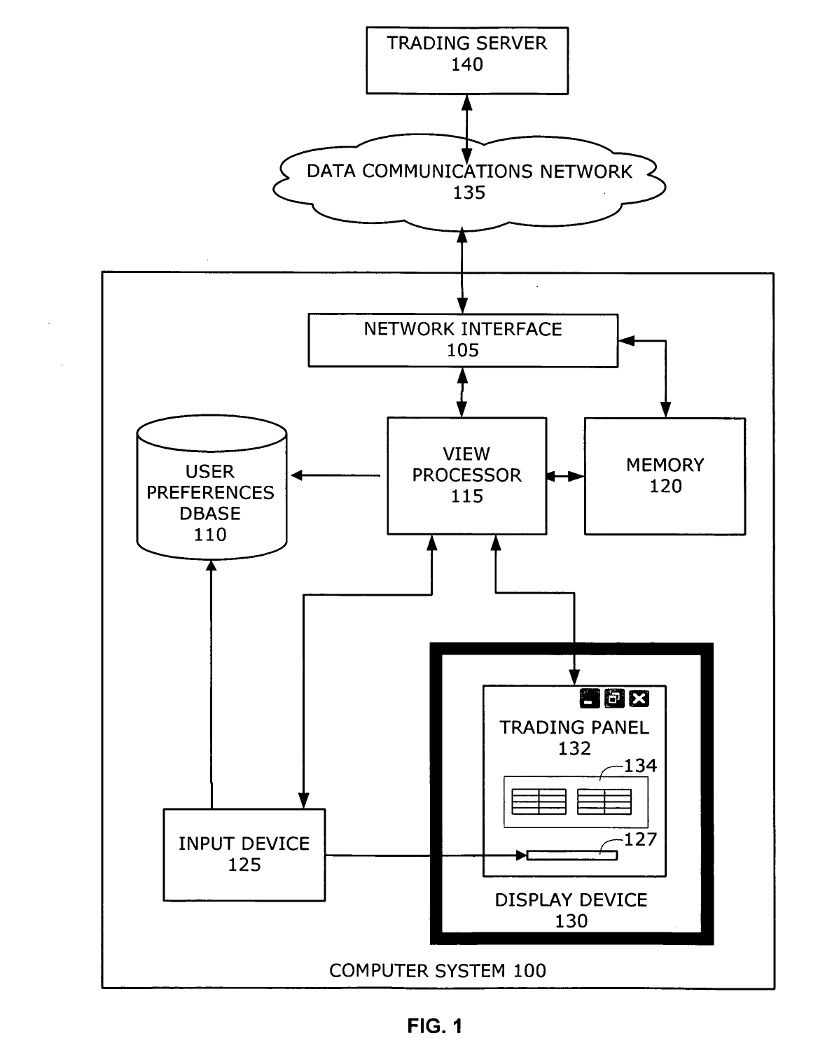

FIG. 1 contains a high-level block diagram illustrating the major functional components of a computer system configured to operate according to an embodiment of the invention. As shown in FIG. 1, computer system 100 comprises a network interface 105, user preferences database 110, view processor 115, memory 120, input device 125 and display device 130. The system is coupled, via the network interface 105 to trading server 140 via data communications network 135. Network interface 105 comprises network adapter cards, adapter card drivers, web server software and hardware, application programming interfaces, etc. typically used to provide data communications between a client computer and a remote online server. Data communications network 135 may comprise any wired or wireless wide area or local area network of interconnected computer systems, such as, for example, the Internet. Computer system 100 may comprise a personal computer or workstation, a personal digital assistant or other handheld computing and networking device, such as a smart mobile telephone.

Typically, network interface 105 receives from the data communications network 135 a set of orders for the instrument to be traded, the set of orders comprising a consolidated snapshot of the market for the instrument, as defined by a plurality of bids and offers that have been submitted to trading server 140. The set of orders may be temporarily stored in a random access memory (RAM) storage area residing on the computer system 100, or alternatively, stored in a non-volatile memory area or hard drive, such as memory 120.

Display device 130 comprises any computer monitor or display panel suitable for displaying text, characters and graphic symbols produced by a microprocessor. View processor 115 comprises any software code or suitably programmed microprocessor configured to generate and display on display device 130 a trading panel 132 comprising a market depth grid 134 for the instrument to be traded. View processor 115 retrieves the set of orders from network interface 105 or memory 120 and performs basic mathematical calculations, as will be discussed below, to generate the size and rate values that will be used to populate market depth grid 134 according to a plurality of available market depth views. The characteristics of the plurality of market depth views may be hard-coded in view processor 115 or alternatively, retrieved from user preferences database 110. The trading panel 132 also includes a control 127, such as a user-activatible button, icon, drop down menu, radio button, or the like, which is configured to permit the user to specify which one of the plurality of available market depth views should be used for the market depth grid 134.

The computer system 100 also includes an input device 125, such as a keyboard, a mouse or other pointing or selection device, which can be operated by a user to activate the control 127 in the trading panel 132 to select a desired market depth view. Activating the control 127 with input device 125 permits the user to select the desired market depth view, which in turn causes view processor 115 to populate the market depth grid 134 with sizes and rates that are derived from the set of orders received from the data communications network 135. As will be described below, the sizes and rates are calculated and displayed in the market depth grid 134 in a manner that is consistent with the selected desired market depth view.

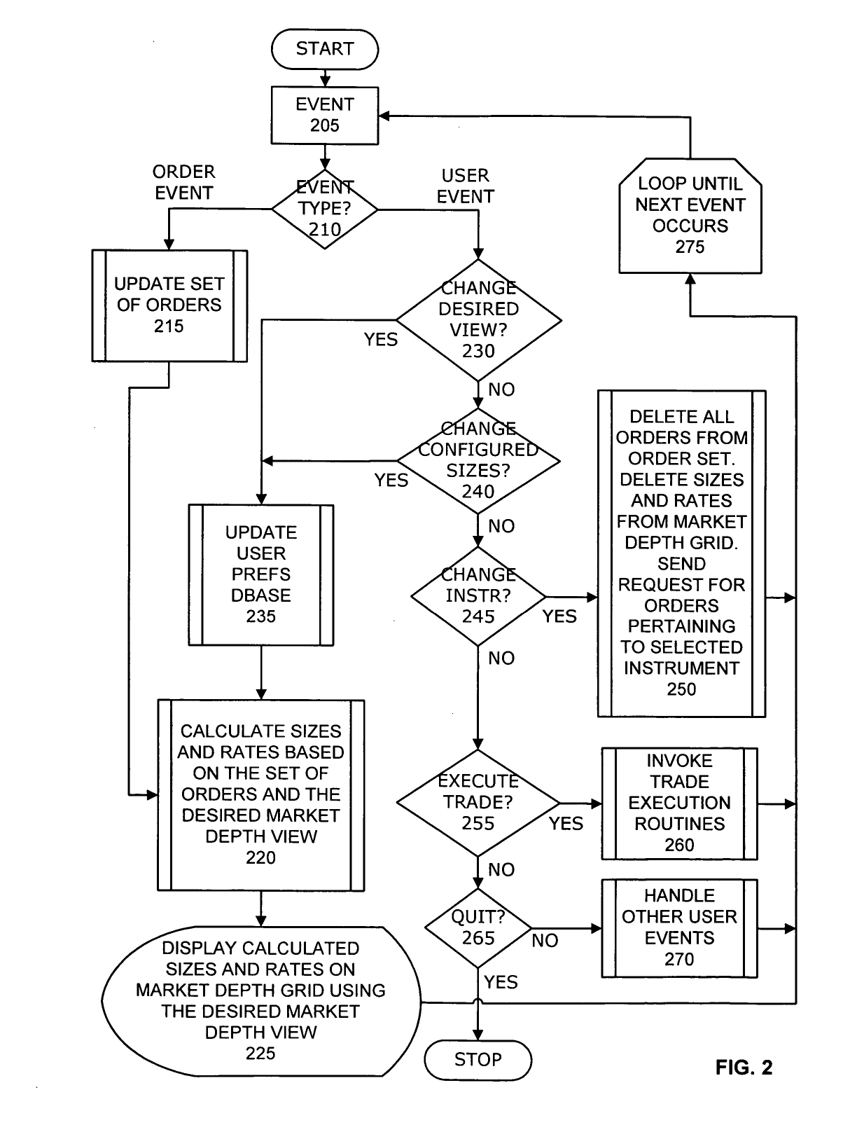

FIG. 2 contains high-level flow diagram illustrating the steps that may be performed by a computer system, such as computer system 100 depicted in FIG. 1, configured to operate according to embodiments of the invention. Generally speaking, the computer system of the present invention is configured to respond to two types of events: order events and user events. An order event occurs when the system receives a new order, a new set of orders, or a request to remove an order from a previously-received set of orders. A user event occurs when the user manipulates the input device 125 to change the desired view, change the configured sizes, change the instrument to be traded, execute a trade or request termination of the program. Accordingly, when an event occurs at step 205, the system first determines, at step 210, which type of event occurred. If the event was an order event (such as when a new or updated set of orders has arrived), then the system updates the set of orders (see step 215) previously-saved in a memory storage area or database.

It should be apparent to those skilled in the computer programming arts that, with respect to receiving order events, the invention may be implemented in a variety of ways. In some embodiments, for example, the system may be configured to periodically receive messages from the trading server, each message containing data reflecting all of the currently active orders for a particular instrument. Thus, each message will essentially comprise a new “snapshot” of the market for that instrument, which snapshot will be used to replace any previously-saved snapshots of the market. In other embodiments, the system may be configured to receive messages that contain data pertaining only to a particular bid or offer. This message may relate to a new bid or offer, or it could comprise an instruction to cancel or remove a previously-received bid or offer. Depending on the preferred implementation, the system updates the set of orders by, for example, overwriting the previously-saved set of orders with a new snapshot, adding a new order to the previously-saved set of orders, or by removing a previously-saved order from the set of orders.

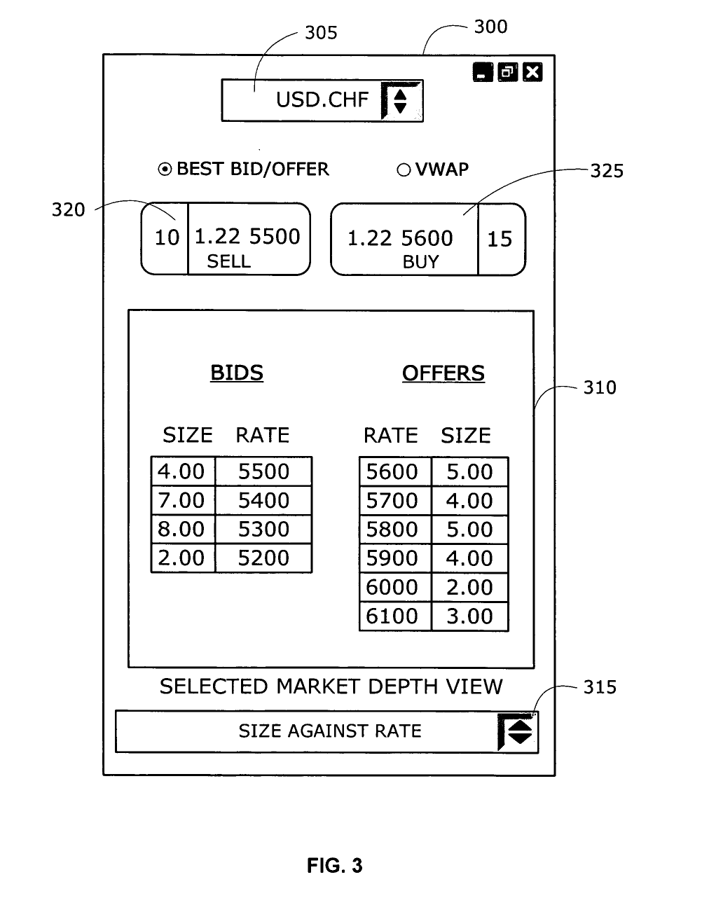

Next, at step 220, the system calculates the sizes and rates to display in the market depth grid based on the set of orders and according to a previously-selected or a default market depth view. The calculations used to accomplish this step will be discussed in more detail below with reference to FIGS. 3 through 8. At step 225, the system populates the market depth grid using the calculated sizes and rates and the desired market depth view, and displays the market depth grid in the trading panel on the display device.

If it is determined at step 210 that the event which occurred at step 205 was a user event instead of an order event, then the system next determines, at step 230, whether the user operated the input device to activate the control on the trading panel to select a new view. If the answer is yes, then the system will update the user preferences database (step 235) and then proceed to step 220 to calculate the sizes and rates for the market depth grid according to the newly-selected desired view. On the other hand, if the user did not change the desired view, then the system determines, at step 240, whether the user event occurred because the user operated the input device to change the set of configured sizes. If the user did change the set of configured sizes, then the system again updates the user preferences database to contain the new configured sizes, and then proceeds to step 220 to calculate the sizes and rates that will be used to populate the market depth grid.

If the user event does not comprise an instruction to change the desired view or set of configured sizes, the system next determines, at step 245, whether the user operated the input device to select a new instrument to be traded. If a new instrument was selected, then the system deletes from memory any previously-saved orders and deletes from the market depth grid on the trading panel all sizes and rates associated with the previously-selected instrument (see step 250). The system also sends a request to the trading server to provide orders pertaining to the newly-selected instrument. Next, as shown in step 275, the system will enter into a programming loop wherein it will look and wait for the next event to occur.

If it is determined at step 245 that the user did not change the instrument, then the system next determines, at step 255, whether the user operated the input device to execute a trade (i.e., to accept one or more bids or offers in the marketplace). In preferred embodiments, this may be accomplished, for example, by operating a keyboard, mouse or other input device to select one of the sizes or rates displayed in the market depth grid on the trading panel. When the user operates the keyboard, mouse or other input device to select a size shown in the market depth grid, the system invokes one or more trade execution routines to execute a trade for the instrument (step 260). Typically, although not necessarily, the trade initiated by selecting a size value will have a size component equal to the selected size value. In preferred embodiments, however, the trade execution routines will generate a dialog box that will allow the user to change the size of the trade before execution. Similarly, when the user activates the keyboard, mouse or other input device to select a rate shown in the market depth grid, the system invokes the trade execution routines to execute a trade using a rate component equal to the selected rate. Trade execution routines are well known in the online trading business and, therefore, will not be described in detail here.

Finally, if it is determined at step 255 that the user did not send a request to execute a trade, the system determines, at step 265, whether the user sent a request to quit the program. If so, then processing stops. If the user did not send an instruction to quit, the system may be configured to handle other types of user events that may occur (step 270). Once the user event has been determined and handled, processing continues at step 275, where the system again enters a programming loop to wait and look for the next event to occur.

FIG. 3 contains an exemplary trading panel 300 that could be used for trading instruments according to one embodiment of the present invention. As shown in FIG. 3, trading panel 300 comprises instrument selection control 305, market depth grid 310 and control 315. Instrument selection control 305 may be activated through the operation of an input device, such as a keyboard or mouse, to select the instrument for which the user wishes to see bids and offers. In this case, the selected instrument is a foreign exchange instrument wherein one party agrees to trade U.S. dollars (USD) against Swiss francs (CHF). It should be apparent to those skilled in the online trading business that the invention will work equally well for trading other kinds of assets, including, for example, money market instruments, stocks and commodities.

Market depth grid 310 comprises four columns reflecting the sizes and rates for bids and offers in the market for the USDCHF instrument. In this case, the sizes and rates have been calculated according the “size against rate” view, which may be selected by operation of the input device to activate control 315. The bid and offer rate columns show the values for the last four decimal places in the plurality of bids and offers associated with the instrument. For this instrument, it is typical to use only the last four decimal places in the market depth grid because the preceding whole number and first two decimal places for bids and offers pertaining to the USDCHF instrument usually do not change from one bid or offer to the next. Accordingly, a bid rate value of “5500” in the market depth grid would be interpreted to mean that one or more traders have submitted bids to buy U.S. dollars at the rate of “1.225500.” The whole number and first two decimal places usually appear elsewhere in the trading panel. In the example shown in FIG. 3, for instance, the whole number and first two decimal places are shown in the optional best quote buttons (320 and 325), which are configured to show the best bid and the best offer for the instrument.

The bid and offer size columns show the consolidated size for bids and offers at each rate. Thus, assuming that the size values in the grid reflect the amount available in millions of U.S. dollars, the row containing the values 4.0, 5500, 5600 and 5.0 may be interpreted by the user to mean that the total consolidated size of all bids having a rate component of 5500 is 4.0 million U.S. dollars and the total consolidated size of all offers having a rate component of 5600 is 5.0 million U.S. dollars. Therefore, the user will understand that if he needs to sell 15 million U.S. dollars, he would get three different rates (1.225500 for the first 4 million U.S. dollars, 1.225400 for the next 7 million U.S. dollars, and 1.225300 for the last 4 million U.S. dollars). Similarly, if the user needed to buy 15 million U.S. dollars, he would get four different rates (1.225600 for the first 5 million, 1.225700 for the next 4 million, 1.225800 for the next 5 million, and 1.225900 for the last 1 million).

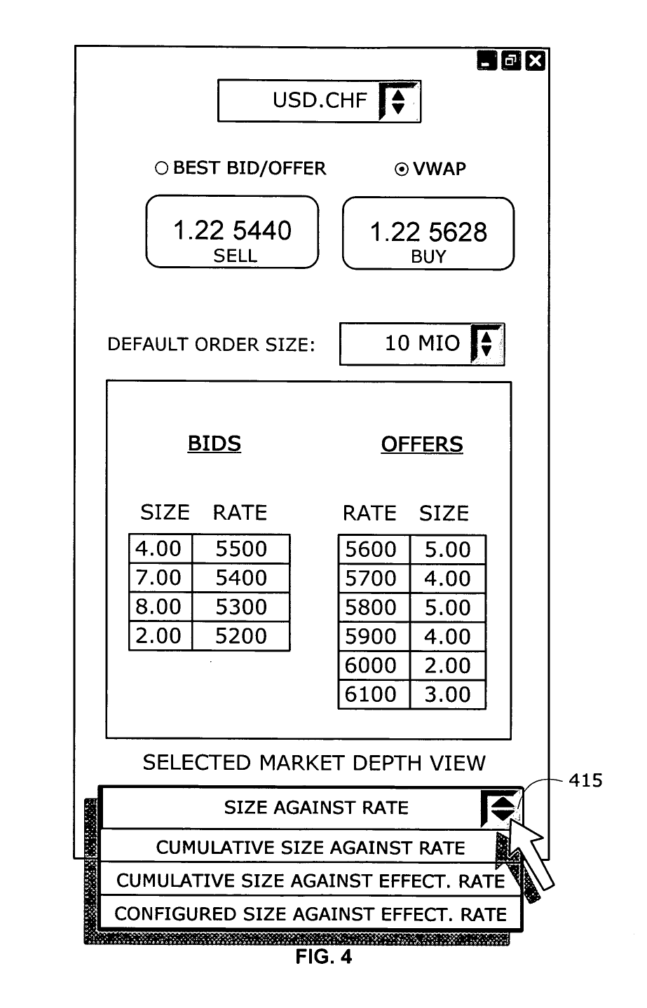

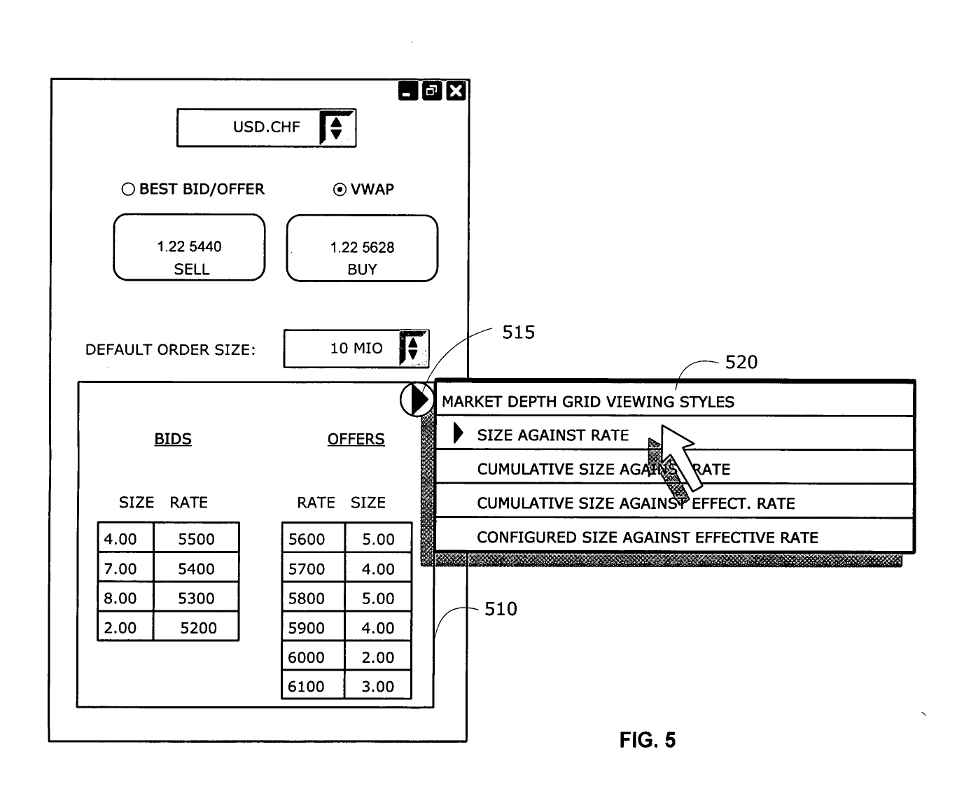

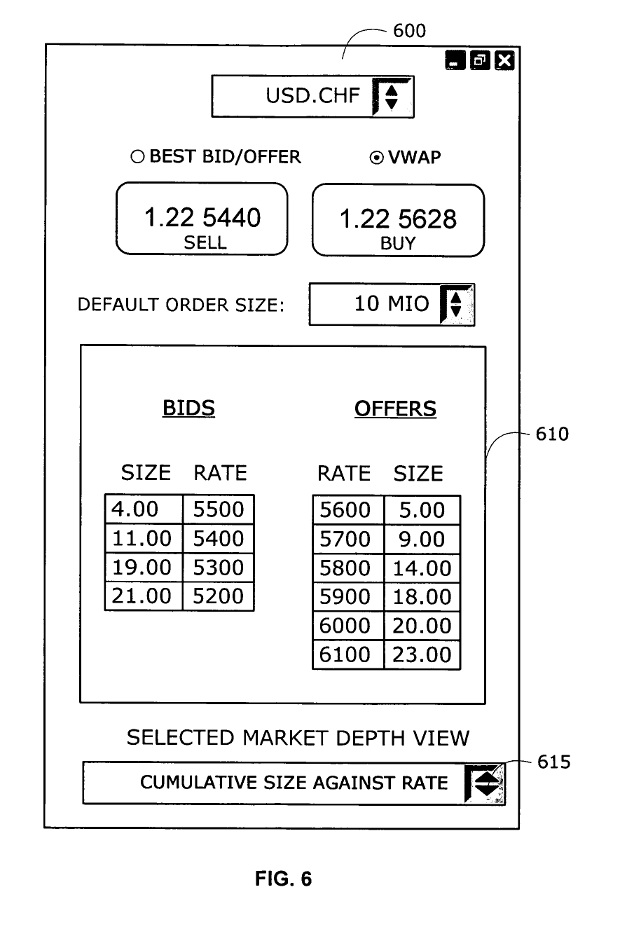

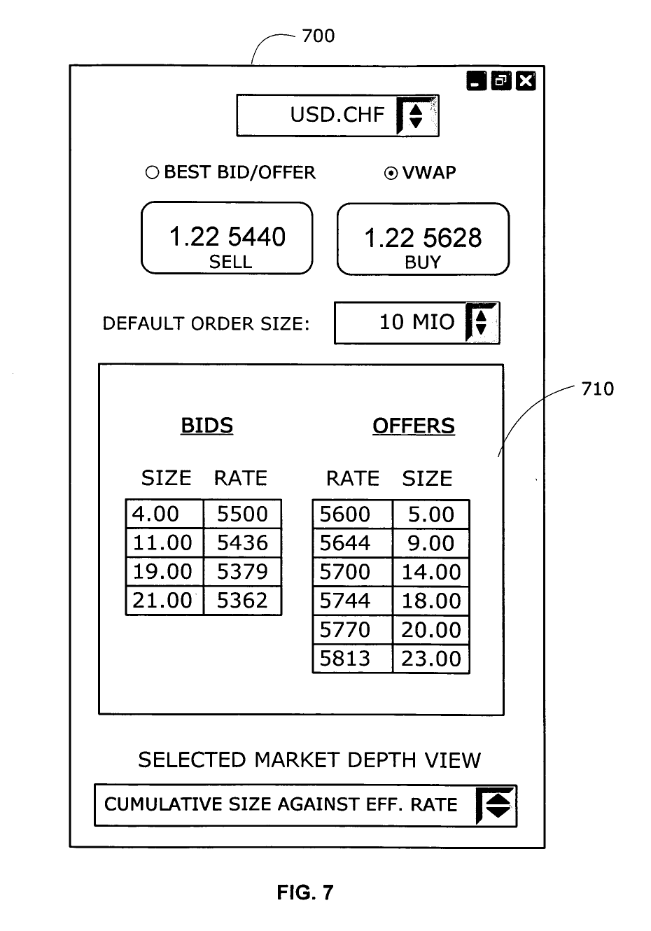

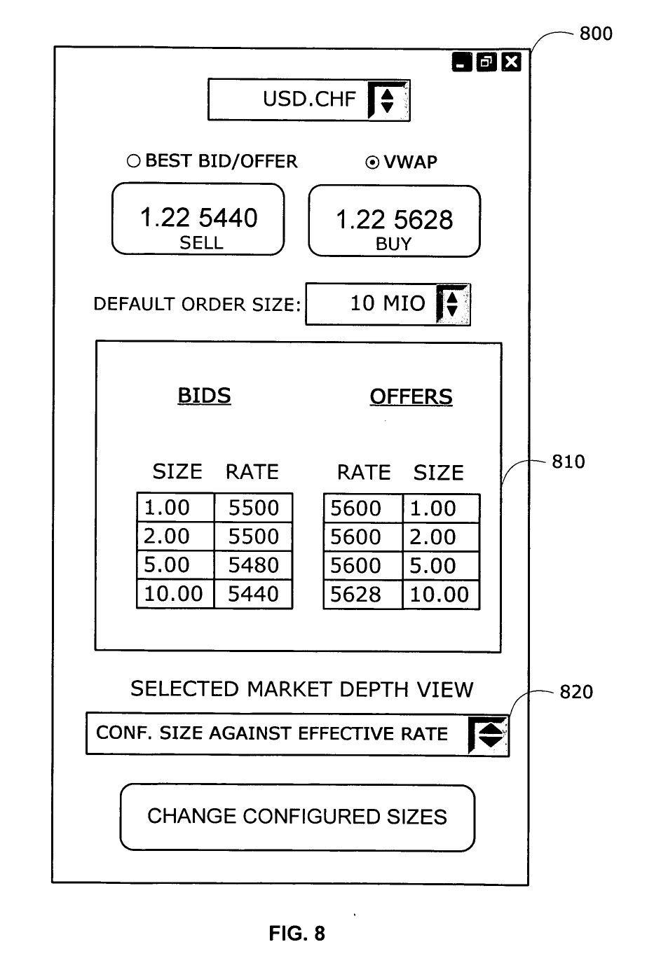

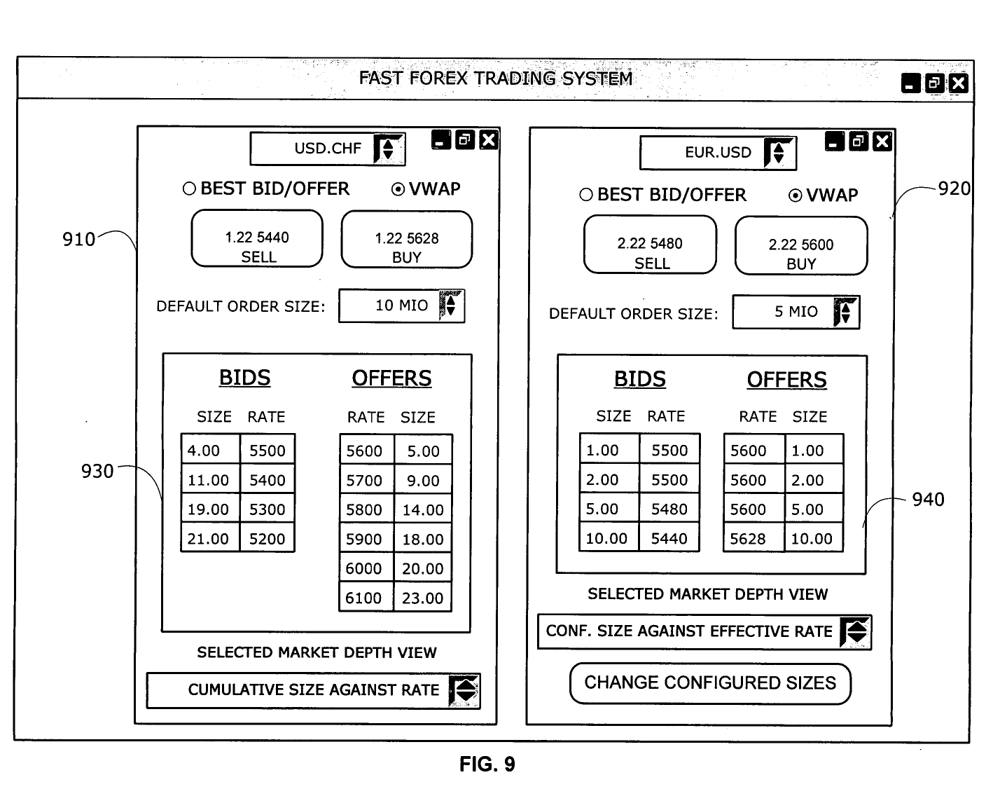

The invention permits users to dynamically switch between a plurality of available market depth views prior to executing an order by operating an input device to activate control 315 on trading panel 300. FIGS. 4 and 5 show two techniques that could be used to provide this dynamic switching functionality. As shown in FIG. 4, control 415 comprises a drop down selection menu which contains four different market depth views. These views include the “size against rate” view, examples of which are shown in FIGS. 3, 4 and 5, the “cumulative size against rate” view, examples of which are shown in FIGS. 6 and 9, the “cumulative size against effective rate” view, an example of which is shown in FIG. 7, and the “configured size against effective rate” view, examples of which are shown in FIGS. 8 and 9.

While the example screen of FIG. 4 shows an implementation in which the control for switching between the multiple views always shows the selected view, the example of FIG. 5 shows an implementation wherein the view switching control (control 515) comprises a right-facing arrow in the upper right hand corner of market depth grid 510. When the user operates the input device, such as a mouse, to activate control 515, a selection menu 520 appears, which permits the user to see the selected view and also select a new view from the plurality of available market depth views. Selecting one of the available market depth views will cause the system to produce a new market depth grid substantially immediately (i.e., in real time) containing sizes and rates consistent with the desired market depth view.

FIG. 6 contains an example of a trading panel 600 comprising a market depth grid containing sizes and values corresponding to the “cumulative size against rate” view. The cumulative size against rate view was selected when the user operated the input device to activate control 615. Notably, the underlying data for the bids and offers may not have changed. However, the sizes shown in the bid and offer size columns of the market depth grid have changed so that they show the cumulative sizes at each rate level. Thus, in response to the selection of the cumulative size against rate view, the system has automatically calculated the cumulative sizes and changed the bid sizes displayed in the market depth grid from 4.0, 7.0, 8.0 and 2.0 to 4.0, 11.0, 19.0 and 21.0, respectively. Using this view, the user can quickly determine, for example, what his worst component rate will be if he were to sell 19.0 million U.S. dollars. In this case, he would immediately see that the worst component rate he would get for selling 19.0 million U.S. dollars is 1.225300. Similarly, he would see from using this view that the worst component rate he would get for buying 19 million U.S. dollars is 1.226000.

FIG. 7 contains an example of a trading panel 700 comprising a market depth grid that has been configured to display sizes and rates according to the “cumulative size against effective rate” view. In this view, the market depth grid displays the cumulative size at each rate level, and the effective rate that would be achieved if the user were to match with the cumulative size. Using this view, the user would immediately see, for example, that if he were to sell 19.0 million U.S. dollars, the effective rate would be 1.225379. The effective rate is calculated by determining the value weighted average rate for the amount bought or sold. Since actual bid rates for each size level, which are shown in the size against rate view depicted in FIG. 3, have not changed, a sell of 19 million means the user would sell 4 million at the rate of 1.225500, 7 million at the rate of 1.225400 and 8 million at the rate of 1.225300. Therefore, the system would calculate the effective rate for a size of 19 million as follows:
Eff.Rate=((4mio*1.225500)+(7mio*1.225400)+(8mio*1.225300))÷19
Eff.Rate=(4.902+8.5778+9.8024)+19
Eff.Rate=23.2822÷19
Eff.Rate=1.225379

Accordingly, and as shown in the example of FIG. 7, selecting the cumulative size against effective rate view for the current set of bids and offers would cause the system to populate the rate field next to the 19.0 size with the value “5379,” indicating to the user that the effective rate would be 1.225379.

FIG. 8 contains an example of a trading panel 800 comprising a market depth grid 810 configured to display sizes and rates corresponding to the “configured size against effective rate” view. When this view is selected, the market depth grid displays sizes that have been configured by the user (in this case, 1.00, 2.00, 5.00 and 10.00), and the effective rate that would be achieved if he were to execute in that size. Using this view, the user can quickly and accurately make a decision as to which size is the most efficient for him to trade. In this instance, the effective rate for each configured size is determined by calculating the value weighted average rate for each configured size. Thus, the user can quickly see that if he sells 5 million, the effective rate for that size is 1.225480. This is because if he sells 5 million, he would get a rate of 1.225500 for the first 4.0 million, and a rate of 1.225400 for the remaining 1.0 million. Therefore, the effective rate is calculated as follows:
Eff.Rate=((4mio*1.225500)+(1mio*1.225400))÷5
Eff.Rate=(4.902+1.2254)÷5
Eff.Rate=6.1274÷5
Eff.Rate=1.225480

As shown in FIG. 8, trading panel 800 includes a control 820, which can be activated with the input device to specify a preferred set of configured sizes. The preferred set of configured sizes are stored in the user preferences database so that the system can retrieve them whenever the user selects the configured size against effective rate view.

FIG. 9 contains an exemplary user interface screen illustrating an embodiment of the invention wherein multiple trading panels 910 and 920 are displayed on the display device simultaneously. In this case, trading panel 910 is configured to display a market depth grid 930 for the instrument USDCHF showing sizes and rates corresponding to the “cumulative size against rate” view, and trading panel 920 is configured to display a market depth grid 940 for the instrument EURUSD showing sizes and rates corresponding to the “configured size against effective rate” view.

Although the invention has been described and illustrated with reference to four different market depth views, it will be understood that embodiments of the invention may be implemented using any number of other possible views without departing from the scope of invention.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims.

What is claimed is:

1. A computer system for trading an instrument using a data communications network, the computer system comprising:
a network interface for receiving a set of orders for the instrument from the data communications network;
a display device;
a view processor configured to display on the display device a trading panel comprising a market depth grid for the instrument and a control, the control being configured to provide access to a plurality of available market depth views for the market depth grid; and
an input device that can be operated by a user to activate the control to select a desired market depth view from the plurality of available market depth views;
wherein activating the control to select the desired market depth view causes the view processor to populate the market depth grid with sizes and rates that are derived from the set of orders and consistent with the desired market depth view;
whereby, prior to initiating a trade on the instrument, the user can selectively view market depth information for the instrument in a plurality of styles, each style corresponding to one of the plurality of available market depth views.

2. The computer system of claim 1, wherein the plurality of market depth views comprises at least one of the following:
a size against rate view,
a cumulative size against rate view,
a cumulative size against effective rate view, and
a configured size against effective rate view.

3. The computer system of claim 1, wherein the plurality of market depth views comprises all of the following:
a size against rate view,
a cumulative size against rate view,
a cumulative size against effective rate view, and
a configured size against effective rate view.

4. The computer system of claim 1, further comprising:
a memory for storing the set of orders; and
the view processor retrieves the set of orders from the memory.

5. The computer system of claim 1, further comprising:
a user preferences database; and
the desired market depth view is stored in the user preferences database.

6. The computer system of claim 1, wherein:
the trading panel further comprises a second control for specifying a preferred set of configured sizes;
the input device can be operated to activate the second control; and
responsive to activation of the second control, the view processor will populate the market depth grid with sizes that are equal to the preferred set of configured sizes and rates that are derived from the set of orders and the preferred set of configured sizes.

7. The computer system of claim 1, wherein:
the trading panel further comprises an instrument selection control which can be activated by the input device to select from a plurality of instruments that may be traded on the data communications network; and
operating the input device to select the new instrument causes the view processor to delete the sizes and rates from the market depth grid.

8. The computer system of claim 7, wherein operating the input device to select the new instrument further causes the view processor to delete the set of orders.

9. The computer system of claim 1, wherein:
the network interface receives a new set of orders for the instrument; and
responsive to receiving the new set of orders, the view processor will re-populate the market depth grid with sizes and rates that are derived from the new set of orders and consistent with the desired market depth view.

10. The computer system of claim 9, further comprising:
a memory for storing the new set of orders; and
the view processor retrieves the new set of orders from the memory.

11. The computer system of claim 1, wherein activation of the input device to select a size shown in the market depth grid executes a trade for the instrument, the trade having a size component equal to the selected size.

12. The computer system of claim 1, wherein activation of the input device to select a rate shown in the market depth grid executes a trade for the instrument, the trade having a rate component equal to the selected rate.

13. A method for trading an instrument using a data communications network, the method comprising:
providing a network interface which receives a set of orders for the instrument from the data communications network;
providing a display device and an input device;
displaying on the display device a trading panel comprising a market depth grid for the instrument and a control that can be activated by the input device to select a desired market depth view for the market depth grid from a plurality of available market depth views; and
in response to receiving the selection of the desired market depth view, populating the market depth grid with sizes and rates that are derived from the set of orders and consistent with the desired market depth view;
whereby, prior to initiating a trade on the instrument, a user can selectively view market depth information for the instrument in a plurality of styles, each style corresponding to one of the plurality of available market depth views.

14. The method of claim 13, wherein the plurality of market depth views comprises at least one of the following:
a size against rate view,
a cumulative size against rate view,
a cumulative size against effective rate view, and
a configured size against effective rate view.

15. The method of claim 13, wherein the plurality of market depth views comprises all of the following:
a size against rate view,
a cumulative size against rate view,
a cumulative size against effective rate view, and
a configured size against effective rate view.

16. The method of claim 13, further comprising:
providing a memory;
storing the set of orders in the memory; and
retrieving the set of orders from the memory prior to populating the market depth grid.

17. The method of claim 13, further comprising:
providing a user preferences database; and
storing the desired market depth view in the user preferences database.

18. The method of claim 13, further comprising:
receiving a preferred set of configured sizes; and
populating the market depth grid with sizes that are equal to the preferred set of configured sizes and rates that are derived from the set of orders and the preferred set of configured sizes.

19. The method of claim 18, further comprising providing a second control on the trading panel which can be activated with the input device to specify the preferred set of configured sizes.

20. The method of claim 18, further comprising:
storing the preferred set of configured sizes in a memory; and
retrieving the preferred set of configured sizes from the memory.

21. The method of claim 13, further comprising:
providing an instrument selection control on the trading panel which can be activated by the input device to select a new instrument from a plurality of instruments that may be traded on the data communications network;
receiving the selection of the new instrument; and
in response to receiving the selection of the new instrument, deleting the sizes and rates from the market depth grid.

22. The method of claim 21, further comprising deleting the set of orders.

23. The method of claim 13, further comprising:
receiving, via the network interface, a new set of orders for the instrument; and
responsive to receiving the new set of orders, re-populating the market depth grid with sizes and rates that are derived from the new set of orders and consistent with the desired market depth view.

24. The method of claim 23, further comprising:
providing a memory;
storing the new set of orders in the memory; and
retrieving the new set of orders from the memory prior to re-populating the market depth grid.

25. The method of claim 13, further comprising executing a trade for the instrument in response to activation of the input device to select a size shown in the market depth grid, the trade having a size component equal to the selected size.

26. The method of claim 13, further comprising executing a trade for the instrument in response to activation of the input device to select a rate shown in the market depth grid, the trade having a rate component equal to the selected rate.
